(19) United States
(12) Patent Application Publication
(10) Pub. No.: US 2012/0292165 A1
(43) Pub. Date: Nov. 22, 2012

(54) SWITCH INTEGRATED LED LAMP DEVICE

(75) Inventor: Yasuo Suzuki, Makinohara-shi (JP)

(73) Assignee: YAZAKI CORPORATION, Tokyo (JP)

(21) Appl. No.: 13/574,963

(22) PCT Filed: Jan. 24, 2011
(86) PCT No.: PCT/JP2011/051227

§ 371 Date: Jul. 24, 2012

(30) Foreign Application Priority Data
Jan. 25, 2010 (JP) 2010-012896

(51) Int. Cl. H01H 15/02

(52) U.S. Cl. 200/313

(57) ABSTRACT

A switch integrated LED lamp device, includes a slide type switch knob, a LED body, a cover, busbars and an insulating housing. The LED body is held in the switch knob. The cover makes the switch knob to be slidably exposed in an opening. The busbars contact with terminal parts of the LED body. The insulating housing fixes the busbars. Spring parts which press the LED body against the busbars are provided in the switch knob.

### TECHNICAL FIELD

This invention is related to a switch integrated LED lamp device which is suitable, for example, for an indoor room lamp or map lamp of a vehicle.

### BACKGROUND ART

FIG. 14 is a figure which shows one embodiment of a conventional LED lamp device (refer to a PTL 1).

In the LED lamp device 61, an LED connection body is formed by connecting a pair of front and back L-shaped terminal parts 63 to an LED body 62, and positioning pieces 65 of three directions and an elastic contact piece 66 are formed in each of front and back busbars 64 by being cut and raised. The terminal parts 63 are connected by being inserted from above into the inside of the positioning pieces 65 and the elastic contact piece 66, and the LED connection body can be drawn out upwards when the LED connection body is removed. The LED is a light emitting diode.

### CITATION LIST

### Patent Document

[PTL 1] JP-A-2006-13018 (FIGS. 3 to 4)

### SUMMARY OF INVENTION

### Technical Problem

However, in the above-mentioned conventional LED lamp device, when the LED body 62 is on or off (turned on or off), a switch structure has to be provided separately, and there is a concern that the number of components will increase and the structure will be complicated. Especially when the switch structure is a slide type one, the contact condition may deteriorate easily due to sliding wear, backlash or the like of the terminal parts 63 and the busbars 64, and there is a concern that it is difficult to secure a good electric contact for a long time.

In view of the above points, the invention is intended to provide a switch integrated LED lamp device which makes it possible to prevent the increase of component numbers and the complication of the structure and to smoothly and definitely turn on/off an LED body with a slide type switch structure, and makes it possible to improve the reliability of the electrical connection of the LED body and busbars.

### Solution To Problem

According to a first invention of the invention, there is provided a switch integrated LED lamp device, comprising:

a slide type switch knob;

an LED body which is held in the switch knob;

a cover which makes the switch knob to be slidably exposed in an opening;

busbars which contact with terminal parts of the LED body; and

an insulating housing which fixes the busbars,

wherein spring parts which press the LED body against the busbars are provided in the switch knob.

With the above-mentioned structure, the LED body moves together with the switch knob and the terminal parts of the LED body slide on the busbars so that, for example, the LED body is turned on at a contact position with the busbars, and the LED body is turned off at a non-contact position with the busbars. Since the LED body is elastically pressed against the busbars by the spring parts, the contact of the terminal parts and the busbars is ensured.

According to a second invention of the invention, there is provided a switch integrated LED lamp device according to the first invention, wherein the LED body is held between a pair of right and left ribs of the switch knob, and is pressed against the busbars by a pair of front and back spring parts.

With the above-mentioned structure, the LED body is held by the pair of right and left ribs without being displaced in the right and left direction (the LED body is slidable in the up-down direction along the pair of ribs), and is pressed against the busbars by the pair of front and back spring parts. The directions of front, back, right, left, up and down are used to facilitate the explanation (front, back, right and left are referred to as four directions). For example, the front and back direction may be the sliding direction of the switch knob or may be perpendicular to the slide direction of the switch knob (although the right and left direction of the pair of right and left ribs is the sliding direction, the right and left direction may be other directions as long as the displacement of the LED body in sliding can be definitely prevented). For example, a pair of spring parts are formed by being crooked inwards to a J shape, and the LED body is pressed from outside towards inside at the crooked side of the J shape. Thus, the spring parts have a function of preventing the displacement like the ribs.

According to a third invention of the invention, there is provided a switch integrated LED lamp device according to first or second invention, wherein a sliding part of the switch knob is slidably engaged with a rail part of the housing.

With the above structure, because the busbars are arranged in the housing and the switch knob is slidably engaged with the housing, the contact backlash of the switch-knob integrated LED body and the busbars is suppressed to be small, and the electric contact of the terminal parts and the busbars is improved.

According to a fourth invention of the invention, there is provided a switch integrated LED lamp device according to any one of first to third inventions, wherein, in the busbars, a part of a busbar which is a signal circuit is located on an extension part of an end of a busbar of negative pole, a busbar of positive pole is located in parallel with the busbar of negative pole and is extended further than the end, and the terminal parts of the LED body are arranged along the busbars of positive pole and negative pole.

With the above structure, when the switch knob is at the middle position, the pair of terminal parts of the LED body contact the busbar of positive pole and the part of the busbar which is the signal circuit, and thus the LED body is turned on by being linked to the signal circuit (for example, a courtesy lamp circuit of an automobile is an example of the signal circuit). When the switch knob is at the front position, the terminal parts depart (separate) from the busbar of the signal circuit, and the LED body is turned on by contacting with the busbars of positive pole and negative pole. When the switch knob is at the back position, the terminal parts depart (separate) from the busbars of negative pole and the switch circuit, and the LED body is turned off by only contacting with the busbar of positive pole.

### Advantageous Effects of Invention

According to the first invention, the LED body is made to be slid together with the switch knob by being arranged in the switch knob. Therefore, the LED body can be made to be on/off (lighting/putting out lights) smoothly, it is not necessary to provide a switch component separately, and the lamp structure can be simplified, compact, and cost-saving. Since the LED body is pressed against the busbars by the spring parts, the reliability of the electrical connection of the LED body and the busbars can be improved and loose connection due to vibration of the vehicle or the like can be prevented.

According to the second invention, the LED body is positioned by the pair of ribs, and is applied forces towards the busbars by the pair of spring parts. Therefore, the LED body can be made to be slid smoothly together with the switch knob along the busbars without being displaced.

According to the third invention, since the switch knob is slidably engaged with the housing at the side of the busbars instead of the cover, the contact backlash of the LED body, which is integrated with the switch knob and the busbars can be prevented, and the reliability of the electrical connection can be improved.

According to the fourth invention, the sliding operation of the switch knob makes the LED body to be turned on by being linked to, for example, a signal circuit or a courtesy lamp circuit of an automobile, and makes the LED body to be turned on or turned off regardless of the signal circuit. Thus, the functions of the switch integrated LED lamp device can be diversified.

### BRIEF DESCRIPTION OF DRAWINGS

FIG. 1 is an exploded perspective view which shows one embodiment of a switch integrated LED lamp device according to the invention.

FIG. 2 is a figure which shows one embodiment of an LED body, in which FIG. 2(a) is a front surface side perspective view, and FIG. 2(b) is a back surface side perspective view.

FIG. 3 is a perspective view which shows the back surface side of a switch knob.

FIG. 4 is a longitudinal sectional view when the LED body is held between the switch knob and busbars.

FIG. 5 is a back surface side perspective view which shows one embodiment of the assembly of a cover and a housing.

FIG. 6 is a back surface side perspective view which shows one embodiment of a busbar structure.

FIG. 7 is a top view which shows one connection state of the busbars and the LED body.

FIG. 8 is an exploded perspective view which shows one embodiment of the switch integrated LED lamp device according to the invention, in which FIG. 8(a) is a perspective view which shows a door linkage position of the switch integrated LED lamp device which is an assembly of the cover, the switch knob, the housing and the like, and FIG. 8(b) is a perspective view which shows an assembly of the housing and the busbars.

FIG. 9 is a sectional view of FIG. 8(a), in which FIG. 9(a) is an A-A sectional view of FIG. 8(a), FIG. 9(b) is a B-B sectional view of FIG. 8(a), and FIG. 9(c) is a C-C sectional view of FIG. 8(b).

FIG. 10 is an exploded perspective view which shows one embodiment of the switch integrated LED lamp device according to the invention, in which FIG. 10(a) is a perspective view which shows an on-position of the switch integrated LED lamp device, and FIG. 10(b) is a perspective view which similarly shows an assembly of the housing and the busbars.

FIG. 11 is a sectional view of FIG. 10(a), in which FIG. 11(a) is a D-D sectional view of FIG. 10(a), FIG. 11(b) is an E-E sectional view of FIG. 10(a), and FIG. 11(c) is an F-F sectional view of FIG. 10(b).

FIG. 12 is an exploded perspective view which shows one embodiment of the switch integrated LED lamp device according to the invention, in which FIG. 12(a) is a perspective view which shows an off-position of the switch integrated LED lamp device, and FIG. 10(b) is a perspective view which similarly shows an assembly of the housing and the busbars.

FIG. 13 is a sectional view of FIG. 10(a), in which FIG. 13(a) is a G-G sectional view of FIG. 12(a), FIG. 13(b) is an H-H sectional view of FIG. 12(a), and FIG. 11(c) is an I-I sectional view of FIG. 12(b).

FIG. 14 is a side (cross section) view which partially shows one embodiment of a conventional LED lamp device.

### DESCRIPTION OF EMBODIMENTS

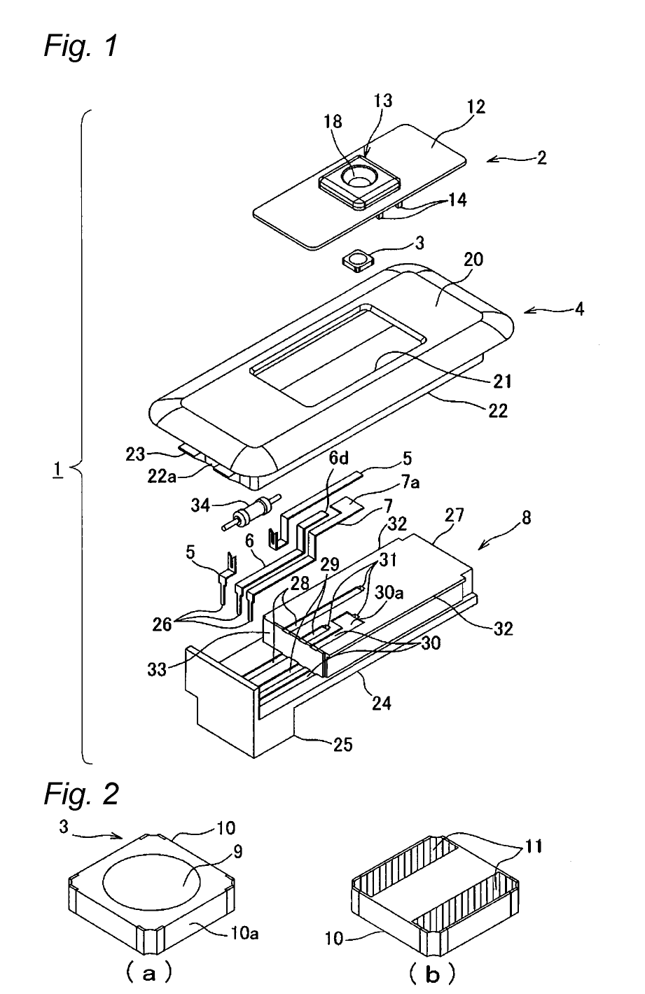

FIG. 1 is a figure which shows one embodiment of a switch integrated LED lamp device according to the invention.

The switch integrated LED lamp device 1 includes a switch knob 2 made of synthetic resin, an LED body 3 which is assembled to the switch knob 2, a cover 4 made of synthetic resin to which the switch knob 2 is slidably assembled, a plurality of busbars 5 to 7 to which the LED body 3 is contacted, and a housing 8 made of insulating resin which is assembled to the cover 4 after the busbars 5 to 7 are assembled.

As shown in FIGS. 2(a) and 2(b), the LED body 3 is formed to be square, flat and board-like, and has a light emitting part (flat light emitting surface) 9 in the center of the front surface. The light emitting part 9 is surrounded by an insulating resin part 10, and a pair of conductive terminal parts (electrodes) 11 which are connected to the light emitting part 9 are provided on the back surface of the insulating resin part 10 nearly on the same plane as the back surface.

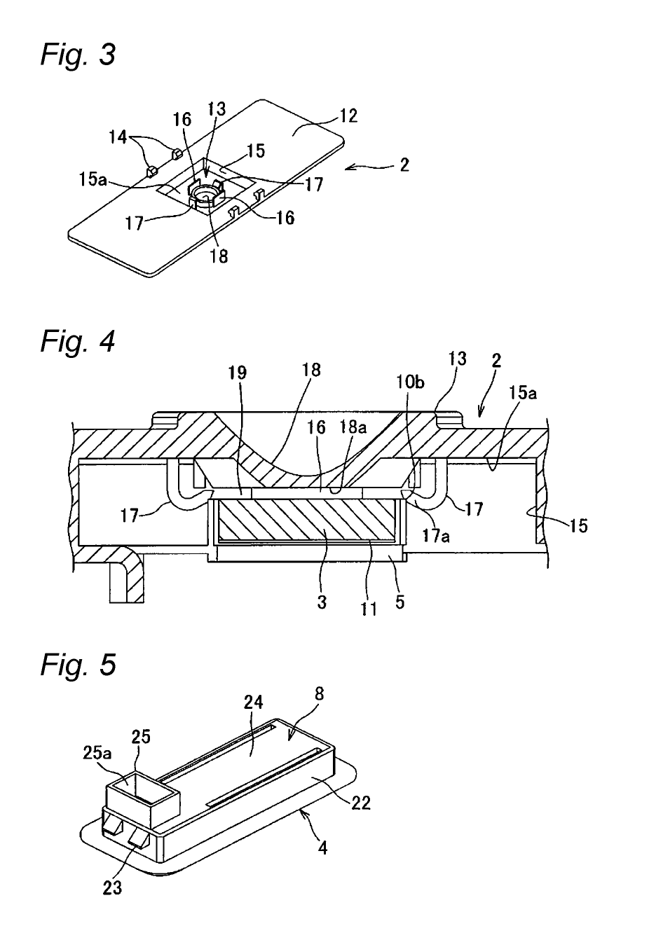

As shown in FIGS. 1 and 3 (a back surface is shown), the switch knob (switch member) 2 includes a rectangular board 12, an LED installing part (operation part) 13 which is integrally provided in the center of the board 12, a pair of front and back flexible hook claws (sliding parts) 14 for the sliding which are integrally provided at the right and left side edges on the back surface of the board 12.

The LED installing part 13 bulges to a rectangular shape from the front surface of the board 12, and becomes an operation part (knob) for the sliding. As shown in FIG. 3, the LED installing part 13 has a pair of right and left restricting ribs 16 and a pair of front and back restricting spring pieces (spring parts) 17 which are vertically projected from the bottom surface (inner surface) 15a of a recess 15 at the back surface side, and has a taper-shaped circular lens part (irradiating part) 18 in the center which is surrounded by the restricting ribs 16 and the restricting spring pieces 17 which are front, back, right and left restricting members. Each of the restricting ribs 16 is projected to be longer than each of the restricting spring pieces 17, so that the side surfaces 10a of the LED body 3 can be held.

As shown in FIG. 4, the front ends of the restricting spring pieces are crooked inwards to a J shape, and the crooked parts 17a apply forces downwards to the upper end edges 10b of the LED body 3 so that the terminal parts 11 on the back surface of the LED body 3 are pressed against the busbars 5 to 7 at the lower side, and elastically contact the busbars 5 to 7. Since the restricting spring pieces 17 are crooked to the J shape and the LED body 3 is pressed from outside to inside (towards the center) by the outer surfaces of the front ends of the crooked parts 17a, the restricting spring pieces 17, like the restricting ribs 16, also have a function of preventing the displacement of the LED body 3. In FIG. 4, the symbol 16 shows the restricting ribs. In this example, the pair of restricting spring pieces 17 are arranged in parallel in the longitudinal direction of the switch knob 2 of FIG. 1, and the pair of restricting rib 16 are arranged in parallel in the transverse direction (cross direction) of the switch knob 2.

The above arrangement may be reversed. The key point is, the side surfaces 10a of the LED body 3 are made to contact the inner surfaces of a pair of opposite restricting ribs 16 so that the displacement of the LED body 3 in the direction of X is prevented by the restricting ribs 16, and the LED body 3 is applied forces towards the busbars 5 to 7 by a pair of opposite restricting spring pieces 17 so that the displacement of the LED body 3 in the direction of Y is prevented by the restricting spring pieces 17. The busbars 5 to 7 are fixed to the housing 8.

When the restricting ribs 16 are provided in the four directions of front, back, right and left, for example, slit-shape notches (not shown in the figure) are provided at the front and back restricting ribs 16, and restricting spring pieces 17 are disposed at the outside of the front and back restricting ribs 16. The upper surface edges 10b of the LED body 3 are pressed by making the crooked parts 17a of the restricting spring pieces 17 to penetrate through the notches. In the description, the directions of front, back, right, left, up and down are used to facilitate the explanation.

The restricting ribs 16 and the restricting spring pieces 17 are raised integrally with the back surface 15a of the recess 15 of the switch knob 2. The upper surface (light emitting surface) of the light emitting part 9 of the LED body 3 is located opposite to the bottom surface 18a of the lens part 18 in the recess 15, and there is a gap 19 between the upper surface and the bottom surface 18a. The shape of the lens part 18 can be set suitably. The LED body 3 moves in the sliding direction of the switch knob 2 together with the switch knob 2. The restricting spring pieces 17 may not be integrated with the switch knob 2. For example, it is possible to make individual restricting spring pieces 17 to be fixed to the back surface of the switch knob 2 by locking means.

As shown in FIG. 1, the cover 4 is formed to a rectangular shape bigger than the switch knob 2. The cover 4 has a rectangular opening 21 which makes the front surface of the switch knob 2 to be exposed in the center of a board wall 20 at the front surface side. The opening 21 is formed to be smaller than the switch knob 2. Front, back, right and left walls (peripheral walls) 22 of a vertical frame shape are formed at the back surface side of the board wall 20. There are lock projections (refer to FIG. 5) 23, which are opposite to attaching sides (rectangular holes of a ceiling panel of an automobile in this example), on the outside surfaces of the front and back walls 22a. The switch knob 2 is located downwards in a vehicle room (in an actual use state), and the LED body 3 irradiates light downwards. The switch knob 2 is installed from the inner surface (back surface) of the board wall 20 to be slidable in the front-back direction (longitudinal direction) (the installed structure is described later).

As shown in FIG. 5, the housing 8 is accommodated inside the peripheral wall 22 of the cover 4. The housing 8 integrally has a connector housing 25 at the front part of a bottom wall 24. The connector housing 25 has a connector fitting room 25a, and becomes a connector (the referential numeral 25 is alternatively used) by accommodating male terminals 26 of the terminals of the busbars 5 to 7 in the connector fitting room.

As shown in FIG. 1, a step-like block wall 27 is integrally formed at the side of the upper surface of the bottom wall 24 of the housing 8. A plurality of (three, in this example) busbar accommodating slots 28 to 30 are provided in parallel in the front-back direction on the upper surface at the connector 25 side (first half) of the bottom wall 24 and on the first half upper surface of the block wall 27. The front ends of the busbar accommodating slots 28 to 30 follow male terminal insertion holes (not shown in the figure) of the connector 25. The busbar accommodating slots 28 to 30 are adjusted to have shapes corresponding to the shapes of the busbars 5 to 7 when viewed from top. The back end of the left busbar accommodating slot 30 is crooked to an L shape, the middle busbar accommodating slot 29 is terminated before the L-shape crooked part 30a, and the right busbar accommodating slot 28 is extended backwards to be longest. Holes 31 for locking the busbars are provided at the back ends of the busbar accommodating slots 28 to 30.

Horizontal flanges (rail parts) 32 are formed at the right and left upper ends of the block wall 27, and the flanges 32 are terminated before the back ends of the block wall 27. The hook claws 14 of the right and left ends of the switch knob 2 are slidably engaged with the flanges 32, and the above-mentioned installed structure is accomplished.

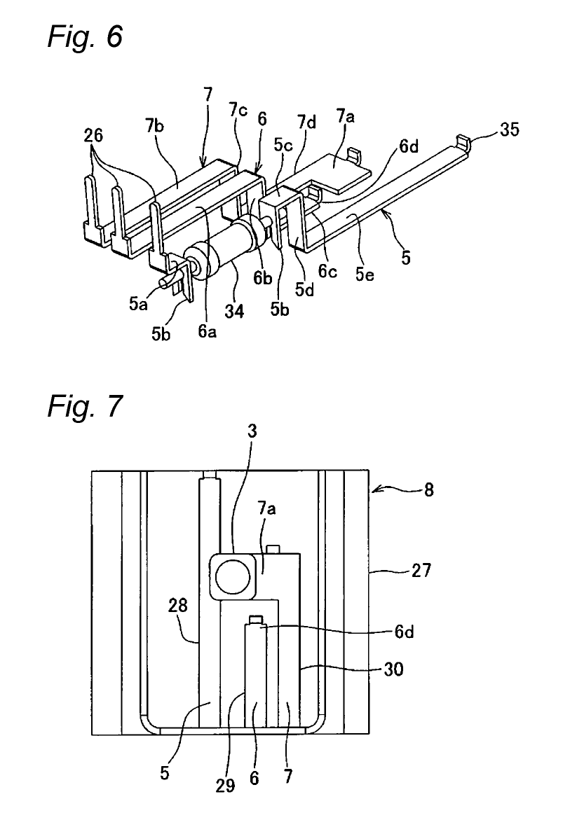

As shown in FIGS. 1 and 6, the busbars 5 to 7 are formed by being suitably bended in accordance with a step-like part 33 of the housing 8 and the male terminal insertion holes (not shown in the figure) of the connector 25. The left busbar 7 in FIG. 1, as shown in FIG. 6, includes a downwards male terminal 26, a first half horizontal part 7b following the male terminal 26, a middle vertical part 7c following the horizontal part 7b, a second half horizontal part 7d following the vertical part 7c, and an intersection board (a part of the busbar) 7a which is horizontally crooked inwards at the back end side of the horizontal part 7d.

The middle busbar 6 includes a downwards male terminal 26, a first half horizontal part 6a, a middle vertical part 6b, and a second half horizontal part 6c, and the intersection board 7a of the left busbar 7 is arranged at the extension (on the same axis line) of the end 6d of the second half horizontal part 6c. The right busbar 5 is divided into two (front and back) busbars, and the two busbars are connected to each other via a resistance 34. The resistance 34 steps down a 12V power supply such as a battery to be used in LED lamps. The front busbar 5 includes a downwards male terminal 26 and a pressure welding piece 5b which is projected upwards from a short horizontal part 5a. The back busbar 5 includes an upwards pressure welding piece 5b, a short horizontal part 5c, a vertical part 5d, and a second half horizontal part 5e. Vertically protruded pieces 35 which are engaged with the holes 31 of the housing 8 (FIG. 1) are provided at the back ends of the busbars 5 to 7.

As shown in FIG. 7, the busbars 5 to 7 are accommodated and arranged (fixed) in the busbar accommodating slots 28 to 30 of the upper wall surface of the block wall 27 of the housing 8. In this example, the right busbar 5 becomes a circuit of the positive (+) pole which is connected to a battery power source, the middle busbar 6 becomes a circuit of the negative (−) pole for grounding and the left busbar 7 becomes a courtesy circuit or a door linkage circuit (signal circuit). In FIG. 7, the terminal parts 11 (FIG. 2) of the LED body 3 touch the intersection board 7a at the back end of the left busbar 7 and the right busbar 5.

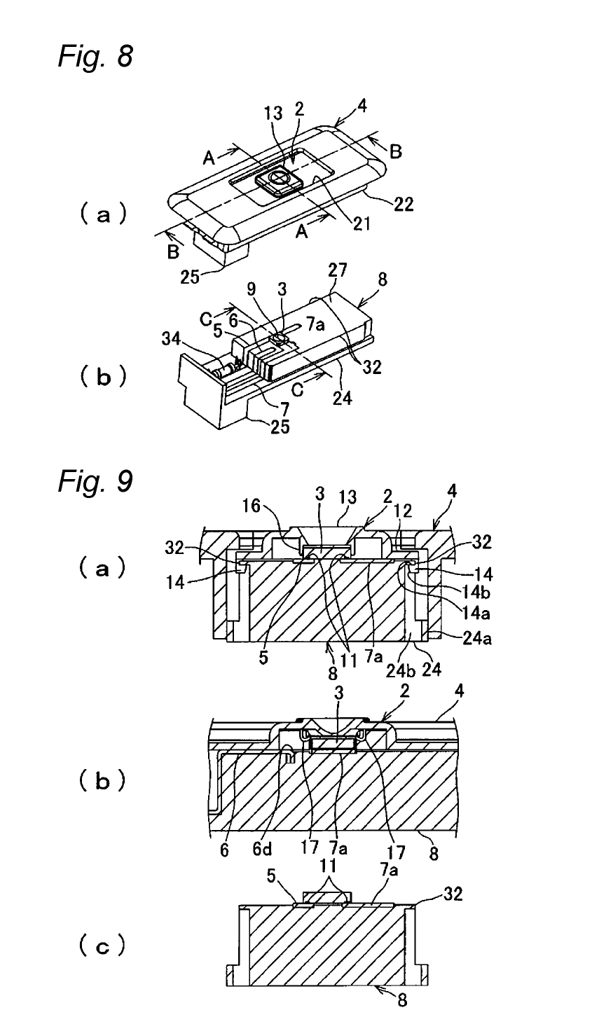

As shown in FIGS. 8(a) and 8(b), when the operation part 13 of the switch knob 2 and the LED body 3 inside the operation part 13 are located in the center of the opening 21 of the cover 4, the LED body 3 is connected to the busbar 5 of the right positive circuit and the busbar 7 of the left door linkage circuit, and at the same time of the turning on of a courtesy lamp (not shown in the figure) of an automobile door when the door is opened, the light emitting part 9 of the LED body 3 is turned on.

As shown in FIG. 9(a) (A-A section of FIG. 8(a)), the flanges (rail parts) 32 at the right and left ends of the block wall 27 of the housing 8 are slidably engaged with guide grooves 14a inside the hook claws 14 which are provided at the right and left side edges of the board 12 of the switch knob 2. The hook claws 14 are engaged by making the lower inclined surfaces 14b to be pressed against and slid on the flanges 32 from above, and in this state, the projected operation part (knob) 13 of the switch knob 2 is assembled by entering into the opening 21 of the cover 4 upwards from below. The side surfaces 24a of the bottom wall 24 of the housing 8 are supported without backlash by contacting with the inner surfaces of the peripheral wall 22 of the cover 4. The LED body 3 is supported by the right and left restricting ribs 16. In FIG. 9, 24b are die cutting holes for the resin molding of the flanges 32.

As shown in FIG. 9(b) (B-B sectional view of FIG. 8 (a)), the LED body 3 can be slid when the LED body 3 is pressed against the busbar 7 by the front and back restricting spring pieces 17 of the switch knob 2. It is preferred to apply grease or the like between the busbars 5 to 7 and the terminal parts 11 of the LED body 3 to reduce the sliding resistance. As shown in FIGS. 9(b) and 9(c) (C-C sectional view of FIG. 8(b)), one terminal part 11 of the LED body 3 contacts the intersection board 7a of the left busbar 7 which is a door linkage circuit in FIG. 8(b), and the other terminal part 11 contacts the right busbar 5 which is a positive circuit. The contacts of the terminal parts 11 and the busbars 5 to 7 are elastically ensured without a gap by the spring forces of the restricting spring pieces 17.

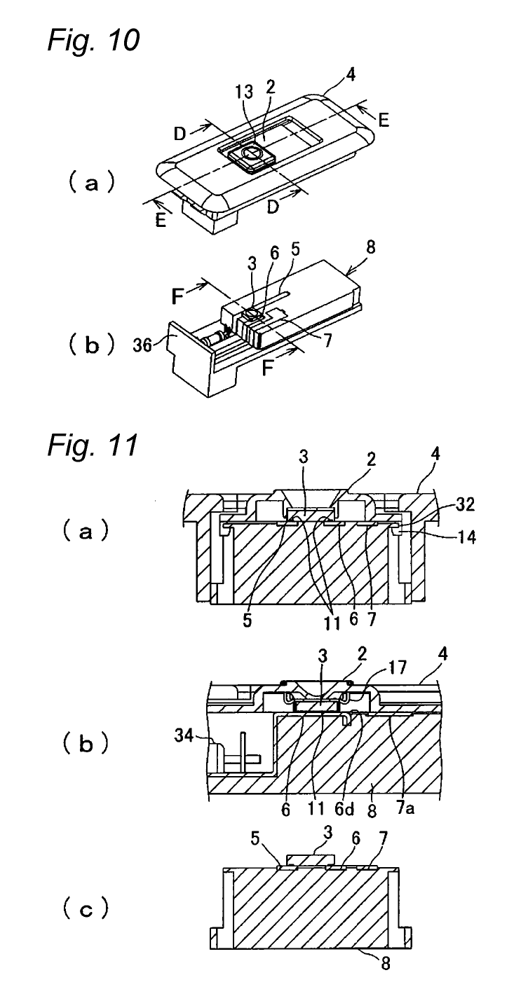

As shown in FIGS. 10(a) and 10(b), when the switch knob 2 is slid forwards, the switch knob 2 stops at a front end position by contacting a stopper (for example, a front end wall 36 of the housing 8 which is raised vertically), The LED body 3 moves together with the switch knob 2 simultaneously, and the terminal parts 11 of the LED body 3 is slid on the surface of the busbars 5 to 7. As shown in FIGS. 11(a) to 11(c), the right busbar 5 of the positive circuit contacts with the middle busbar 6 of the negative circuit, and the light emitting part 9 of the LED body 3 is turned on regardless of the opening and closing of the door. Certainly, the LED body 3 is pressed against the busbars 5 and 6 by the restricting spring pieces 17, and elastically contacts with the busbars 5 and 6.

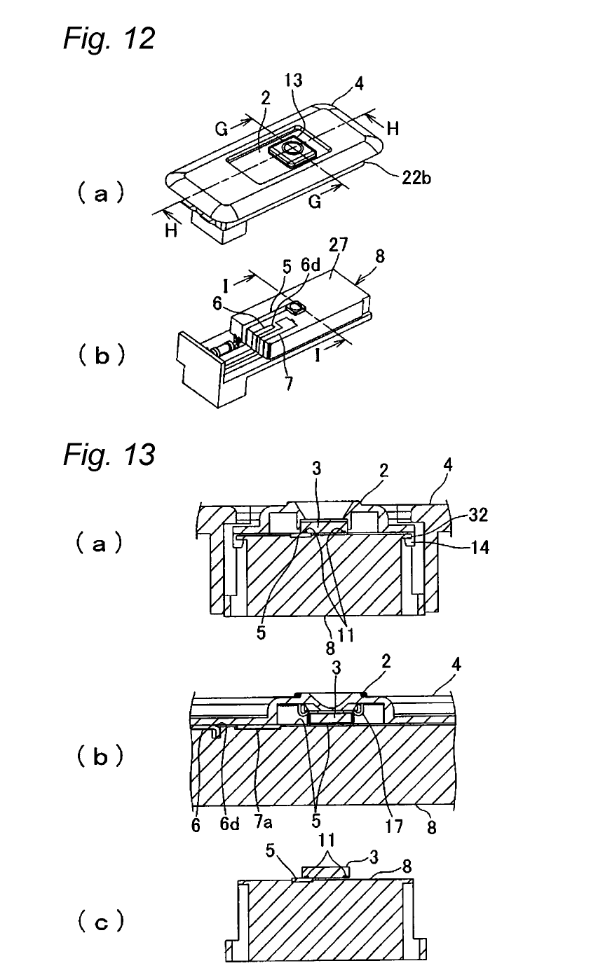

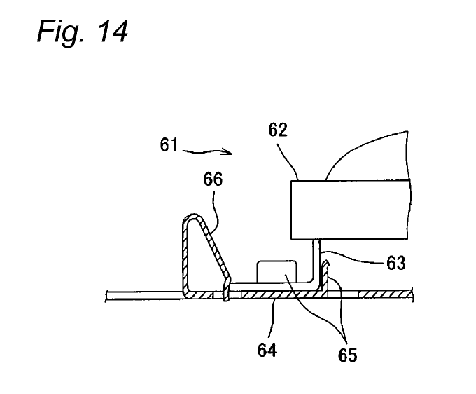

As shown in FIGS. 12(a) and 12(b), when the switch knob 2 is slid backwards, the switch knob 2 stops at a back end position by contacting a stopper (for example, a back wall 22b of the cover 4). The LED body 3 moves together with the switch knob 2 simultaneously, and the terminal parts 11 of the LED body 3 is slid on the surface of the busbars 5 to 7. As shown in FIGS. 13(a) to 13(c), the middle busbar of the negative circuit 6 and the intersection board 7a which is located at the termination of the left busbar 7 of the door linkage circuit are passed, and only one terminal part 11 contacts with the right busbar 5 of the positive circuit. Thus, the light emitting part 9 of the LED body 3 is turned off regardless of the opening and closing of the door. When the switch knob 2 is slid forwards from the state of FIG. 12(b), since the surface of the busbars 5 to 7 and the upper surface of the block wall 27 of the housing 8 are located substantially on the same plane and elastic forces are applied by the restricting spring pieces 17, the LED body 3 moves smoothly without being hooked.

According to the above-mentioned embodiment, the switch knob 2 is usually at a door linkage position, and is slid at the time of the operations of turning on/off. Since the LED body 3 can also be slid integrally with the switch knob 2 by the restricting ribs 16 of the switch knob 2, and conduction points can be changed simultaneously, the functions of both switching and power supplying can be achieved.

Since the switch structure serves as both the switch knob 2 and the light source part 3, that is, the LED body, it becomes unnecessary to provide the switch structure in other parts, and the assembly operation can be performed easily. Since the soldering of the terminal parts 11 of the LED body 3 is unnecessary, the concern that the solder may degrade due to vibration or heat can be eliminated. Since the LED body 3 and the busbars 5 to 7 are made to be welded by pressure directly (press connection), defective conduction may not occur easily.

Thus, without fixing the LED body 3 to the busbars 5 to 7, the busbars 5 to 7 are pressed by the switch knob 2 and made to be conducted, the LED body 3 also moves in accordance with the operations of turning on/off of the switch knob 2, and the conduction points of the busbars 5 to 7 are changed. Therefore, an integrated structure of a switch and a light source part can be obtained which has the functions of both the switch and the light source.

In the above-mentioned embodiment, the switch knob 2 is slidably engaged with the flanges (rail parts) 32 of the housing 8. However, it is also possible to slidably engage the switch knob 2 with rail parts (not shown in the figure) of the cover 4 instead of the housing 8. However, since the contact of the LED body 3 and the busbars 5 to 7 at the side of the housing 8 are ensured without up-down backlash (gap), it is preferred to slidably engage the switch knob 2 with the housing 8.

In the above-mentioned embodiment, the hook claws 14 of the switch knob 2 are sliding parts opposite to the rail parts 32 of the housing 8. However, it is also possible to provide members (not shown in the figure) which has an L shape cross section and is long in the front-back direction integrally in the switch knob 2 to replace the hook claws 14 as the sliding parts, and to slidably engage (fit) the switch knob 2 with the rail parts 32 in the front-back direction instead of from above.

The switch integrated LED lamp device according to the invention can be used in, for example, a room lamp or a map lamp of an automobile to reduce the number of components, to compact the lamp and to improve the reliability of electrical connection.

Although the present invention is described in detail with reference to specific embodiments, it is apparent that various modifications and amendments may be made by those skilled in the art without departing from the spirit and scope of the invention.

This application is based on the Japanese patent application (patent application 2010-012896) filed on Jan. 25, 2010, whose content is incorporated herein by reference.

### REFERENCE SIGNS LIST

1 switch integrated LED lamp device
2 switch knob
3 LED body
4 cover
5 busbar of positive pole
6 busbar of negative pole
6d end
7 busbar of a door linkage circuit (signal circuit)
7a intersection board (part)
8 housing
11 terminal part
14 hook claw (sliding part)
16 restricting rib (rib)
17 restricting spring piece (spring part)
21 opening
32 flange (rail part)

1. A switch integrated LED lamp device, comprising:
a slide type switch knob;
an LED body which is held in the switch knob;
a cover which makes the switch knob to be slidably exposed in an opening;
busbars which contact with terminal parts of the LED body; and
an insulating housing which fixes the busbars,
wherein spring parts which press the LED body against the busbars are provided in the switch knob.

2. The switch integrated LED lamp device according to claim 1,
wherein the LED body is held between a pair of right and left ribs of the switch knob, and is pressed against the busbars by a pair of front and back spring parts.

3. The switch integrated LED lamp device according to claim 1,
wherein a sliding part of the switch knob is slidably engaged with a rail part of the housing.

4. The switch integrated LED lamp device according to any one of claim 1,
wherein, in the busbars, a part of a busbar which is a signal circuit is located on an extension part of an end of a busbar of negative pole, a busbar of positive pole is located in parallel with the busbar of negative pole and is extended further than the end, and the terminal parts of the LED body are arranged along the busbars of positive pole and negative pole.
